(19) United States
(12) Patent Application Publication
(10) Pub. No.: US 2011/0244795 A1
(43) Pub. Date: Oct. 6, 2011

(54) Communication device, communication method, information processing apparatus, information processing method, program, and information processing system

(75) Inventors: Masahiro Sueyoshi, Kanagawa (JP); Naoki Miyabayashi, Tokyo (JP)

(73) Assignee: Sony Corporation, Tokyo (JP)

(21) Appl. No.: 13/065,425

(22) Filed: Mar. 22, 2011

(30) Foreign Application Priority Data
Mar. 30, 2010 (JP) P2010-079187

(51) Int. Cl. H04B 5/00; G06K 19/073

(52) U.S. Cl. 455/41.1; 235/492

(57) ABSTRACT

A communication system and method is provided for use when a device conducts a near field communication (NFC) with a store apparatus. A method includes receiving usage information concerning the NFC at a server in response to the NFC, and storing the usage information in the server, the usage information being associated with the NFC, and the usage information also being stored in the device in response to the NFC; comparing the usage information stored in the device to the usage information stored in the server when a user of the device attempts to upload to the server a review related to the NFC; and receiving the review at the server when the usage information stored in the device corresponds to the usage information stored in the server.

### CROSS-REFERENCE TO RELATED APPLICATION

The present application claims priority from Japanese Patent Application No. JP 2010-079187 filed in the Japanese Patent Office on Mar. 30, 2010, the entire content of which is incorporated herein by reference.

### BACKGROUND

1. Technical Field

The present disclosure relates to a communication device, a communication method, an information processing apparatus, an information processing method, a program, and an information processing system, and specifically, to a communication device, a communication method, an information processing apparatus, an information processing method, a program, and an information processing system adapted to realize new business models using Integrated Circuit (IC) cards represented by FeliCa (registered trademark), cellular phones containing IC chips equivalent thereto, or the like.

2. Description of the Related Art

In the past, noncontact communication IC cards represented by FeliCa (hereinafter, simply referred to as “IC cards”) have been in wide-spread use. Specifically, the IC cards are widely used as commuter passes for trains or the like, electronic money, membership cards, etc. The IC cards can make communication of data only by touching on a reader/writer as the other end of the communication for a moment (the word “touching” being used here and throughout this specification to mean both being brought into contact and being held at a predetermined close range, e.g. within 10 cm). Thus, the IC cards and the reader/writer may be said to conduct near field communication (NFC) with each other. That is, the IC cards and the reader/writer may conduct communication by being in contact or by being within a predetermined close range.

Further, there have been cellular phones containing IC chips equivalent to the above described IC cards. In addition, there have been cellular phones also including communication means that realize P2P communication of Bluetooth (registered trademark) or the like, and handover from noncontact communication using the IC chip to P2P communication using the communication means has been disclosed (For example, see JP-A-2009-44374).

### SUMMARY

As described above, IC cards and cellular phones containing IC chips equivalent thereto have been in widespread use, and, in the future, their utilization for various business models is expected.

In view of the above, it has been recognized that it is desirable to propose new business models using IC cards and cellular phones containing IC chips equivalent thereto or the like.

Accordingly, the present embodiments are provided. In one of the embodiments, a communication system and method is provided. The system and method are for use when a device conducts near field communication (NFC) with a store apparatus. The method includes receiving usage information concerning the NFC at a server in response to the NFC, and storing the usage information in the server, the usage information being associated with the NFC, and the usage information also being stored in the device in response to the NFC; comparing the usage information stored in the device to the usage information stored in the server when a user of the device attempts to upload to the server a review related to the NFC; and receiving the review at the server when the usage information stored in the device corresponds to the usage information stored in the server.

### BRIEF DESCRIPTION OF THE DRAWINGS

FIG. 1 is a block diagram showing a configuration example of an IC card utilization system to which an embodiment of the invention is applied;

FIG. 2 is a block diagram showing a configuration example of an IC card;

FIG. 3 is a block diagram showing a configuration example of an information processing apparatus;

FIG. 4 is a flowchart for explanation of operations of the IC card utilization system;

FIGS. 5A to 5C show display examples of a screen at review writing;

FIGS. 6A to 6C display examples of the screen at review viewing;

FIG. 7 is a block diagram showing a configuration example of a portable terminal utilization system to which an embodiment of the invention is applied;

FIG. 8 is a block diagram showing a configuration example of a portable terminal;

FIG. 9 is a flowchart for explanation of operations of the portable terminal utilization system;

FIG. 10 is a block diagram showing a configuration example of an IC card utilization system to which an embodiment of the invention is applied; and

FIG. 11 is a flowchart for explanation of operations of the IC card utilization system.

### DETAILED DESCRIPTION

As below, the best modes for implementing the invention (hereinafter, referred to as embodiment) will be explained in detail with reference to the drawings. The explanation will be made in the following order.

1. First Embodiment

2. Second Embodiment

3. Third Embodiment

### 1. First Embodiment

### Configuration Example of IC Card Utilization System 10

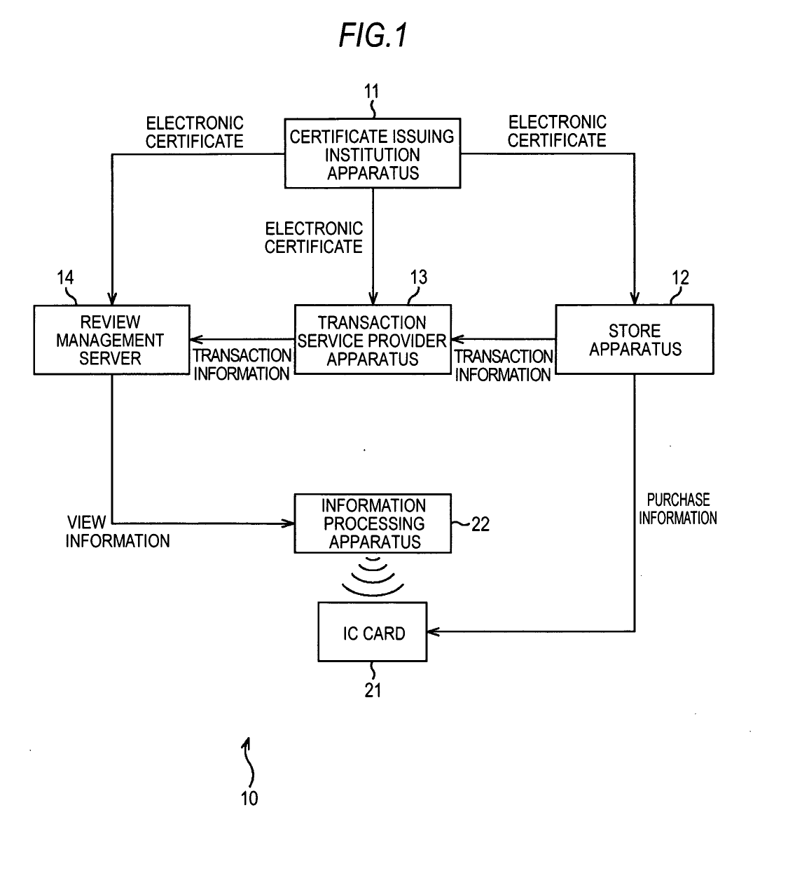

FIG. 1 shows a configuration example of an IC card utilization system 10 as the first embodiment of the invention. The IC card utilization system 10 includes an IC card 21 and an information processing apparatus 22 used by a user, a certificate issuing institution apparatus 11, a store apparatus 12, a transaction service provider apparatus 13, and a review management server 14.

The IC card 21 is an IC card that can make noncontact communication represented by FeliCa, and used as electronic money in the first embodiment. The IC card 21 makes communication of various kinds of data with the information processing apparatus 22 or the store apparatus 12 via a communication port provided in the information processing apparatus 22 or the store apparatus 12.

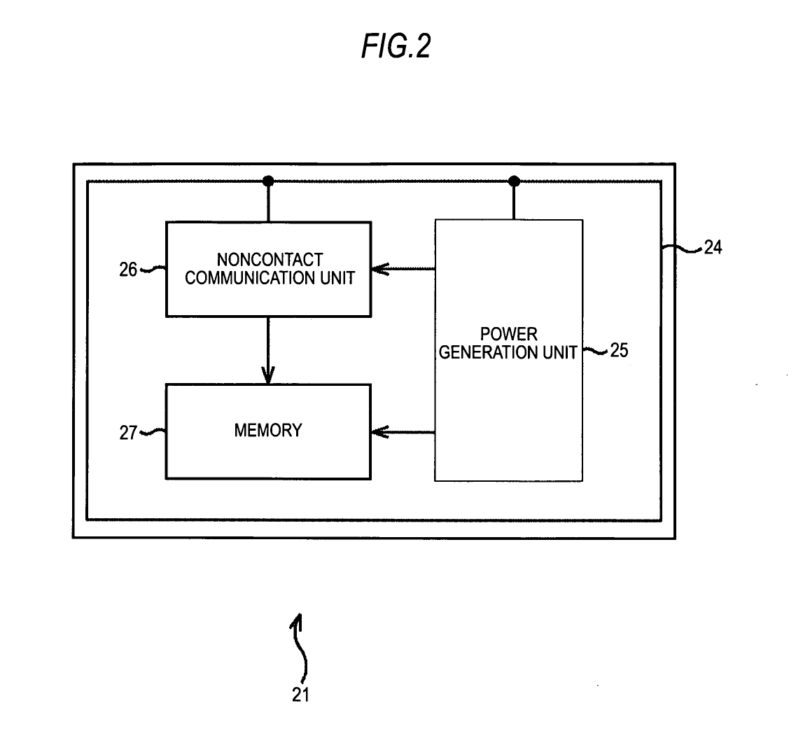

FIG. 2 shows a basic configuration example of the IC card 21. The IC card 21 includes an antenna 24, a power generation unit 25, a noncontact communication unit 26, and a memory 27.

The power generation unit 25 acquires drive power of the IC card 21 based on induced electromotive force generated when electromagnetic wave transmitted from the communication port of the information processing apparatus 22 or the like passes through the inner circumference of the antenna 24, and supplies the power to the noncontact communication unit 26 and the memory 27. The noncontact communication unit 26 receives the data transmitted from the communication port of the information processing apparatus 22 or the like via the antenna 24 and records the data in the memory 27. Further, the noncontact communication unit 26 reads out the data recorded in the memory 27 and transmits the data to the communication port of the information processing apparatus 22 or the like via the antenna 24.

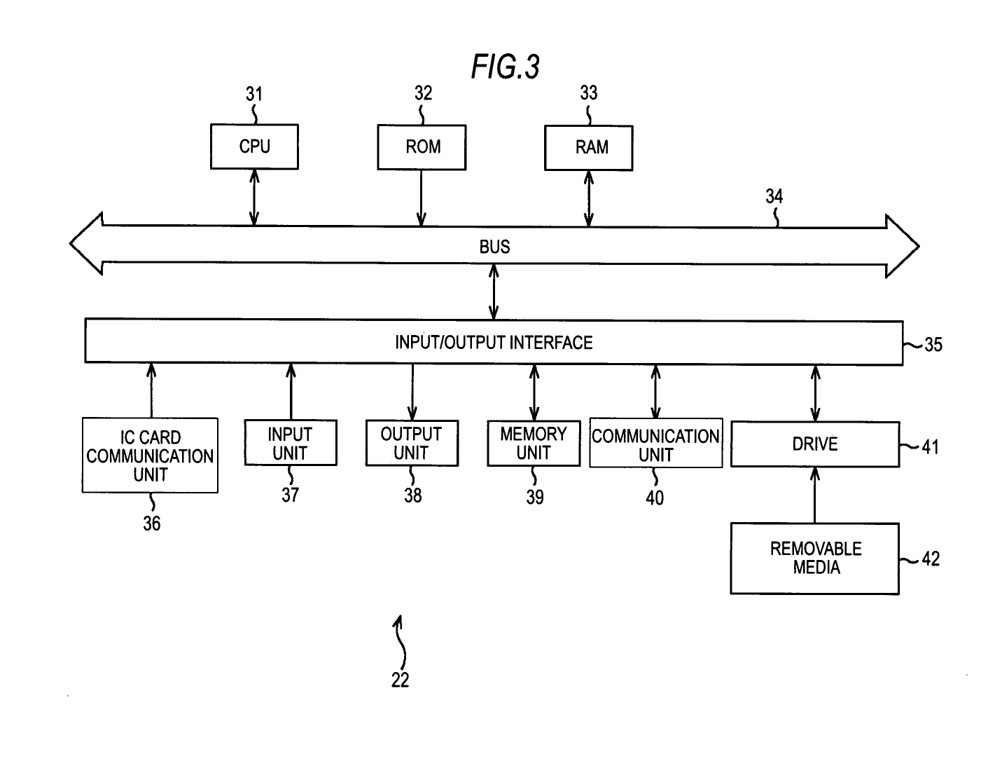

Returning to FIG. 1, the information processing apparatus 22 has the communication port for communication of data with the IC card 21 (an IC card communication unit 36 in FIG. 3). Further, the information processing apparatus 22 can access an arbitrary server (for example, the review management server 14) via the Internet. Therefore, the information processing apparatus 22 may be realized not only by a personal computer but also by a television receiver having a communication port compatible with the IC card and having a function accessible to the arbitrary server via the Internet or the like.

FIG. 3 shows a configuration example of the information processing apparatus 22. In the information processing apparatus 22, a CPU (Central Processing Unit) 31, a ROM (Read Only Memory) 32, and a RAM (Random Access Memory) 33 are connected to one another by a bus 34.

To the bus 34, an input/output interface 35 is further connected. To the input/output interface 35, the IC card communication unit 36 that makes communication of data with the IC card 21, an input unit 37 including a keyboard, a mouse, a microphone, or the like, an output unit 38 including a display, a speaker, or the like, a memory unit 39 including a hard disc, a nonvolatile memory, or the like, a communication unit 40 including a network interface or the like, and a drive 41 that drives removable media 42 are connected. As the removable media 42, for example, a magnetic disc, an optical disc, a magneto-optical disc, a semiconductor memory, or the like may be used.

In the information processing apparatus 22 having the above described configuration, the CPU 31 loads a program stored in the memory unit 39 in the RAM 33 via the input/output interface 35 and the bus 34 and executes it, and thereby, a series of processing, which will be described later, is performed.

Returning to FIG. 1, the certificate issuing institution apparatus 11 is provided in an authorized certificate authority and issues electronic certificates respectively to the store apparatus 12, the transaction service provider apparatus 13, and the review management server 14. The issued certificates are attached to various kinds of information to be transmitted by the store apparatus 12 or the like.

The store apparatus 12 is set in a store that sales products (including a restaurant that provides meals as products or the like), and provided with a communication port (not shown) for noncontact data communication with the IC card 21. When a user who purchases a product touches the communication port with the IC card 21 for payment, the data on transaction (the remaining amount of electronic money, the price of the product, etc.) is communicated between the IC card 21 and the store apparatus 12. Furthermore, concurrently, purchase information is transmitted from the store apparatus 12 to the IC card 21 and recorded in the IC card 21.

The purchase information is used for certification of the actual purchase in the store and an electronic certificate is added thereto. The purchase information includes the date of transaction, the amount of money of transaction, product identification information for identification of the purchased product, store identification information for identification of the respective stores (or the respective POS), and IC card identification information for identification of the used IC card 21.

Further, the store apparatus 12 notifies the transaction service provider apparatus 13 of transaction information corresponding to the payment using the IC card 21. The transaction information includes the date of transaction, the amount of money of transaction, the product identification information, the store identification information, and the IC card identification information.

The transaction service provider apparatus 13 performs transaction processing (for example, processing of subtracting the product price from the prepaid amount of money or processing of charging the product price on the user via a credit company) for the user of the IC card 21 based on the transaction information provided from the store apparatus 12. Further, the transaction service provider apparatus 13 supplies the transaction information also to be a certificate of actual purchase of the product at the store by the user of the IC card 21 to the review management server 14.

The review management server 14 is a server for collecting and disclosing at least one of a review for the store and the product and a visit record by the purchaser who has purchased the product (the user of the IC card 21). Further, the visit record includes the number of visits, the number of purchased items, the numbers of the respective purchased items, etc. Note that the visit record may not be input by the user, but may be extracted from the purchase information or the transaction information and registered. The reviews etc. are uploaded and disclosed using homepages and blogs posted on the Internet. Specifically, the reviews may be displayed in association with the purchased products, or otherwise, marks corresponding to the visit records in association with the reviews (for example, showing the grade of the visit records by the number of stars) may be displayed. In this manner, by disclosing the visit records with the reviews, reliability and credibility of the disclosed reviews may be improved and the reviews uploaded by people who have not actually visit the stores or purchased the products may be removed.

The review management server 14 transmits the disclosed data of the homepages or the like to the information processing apparatus 22 accessed for viewing the disclosed reviews, and also transmits the view information. The view information includes information that proves the user has viewed the review and is recorded in the IC card 21 in the information processing apparatus 22.

### [Operation Explanation of IC Card Utilization System 10]

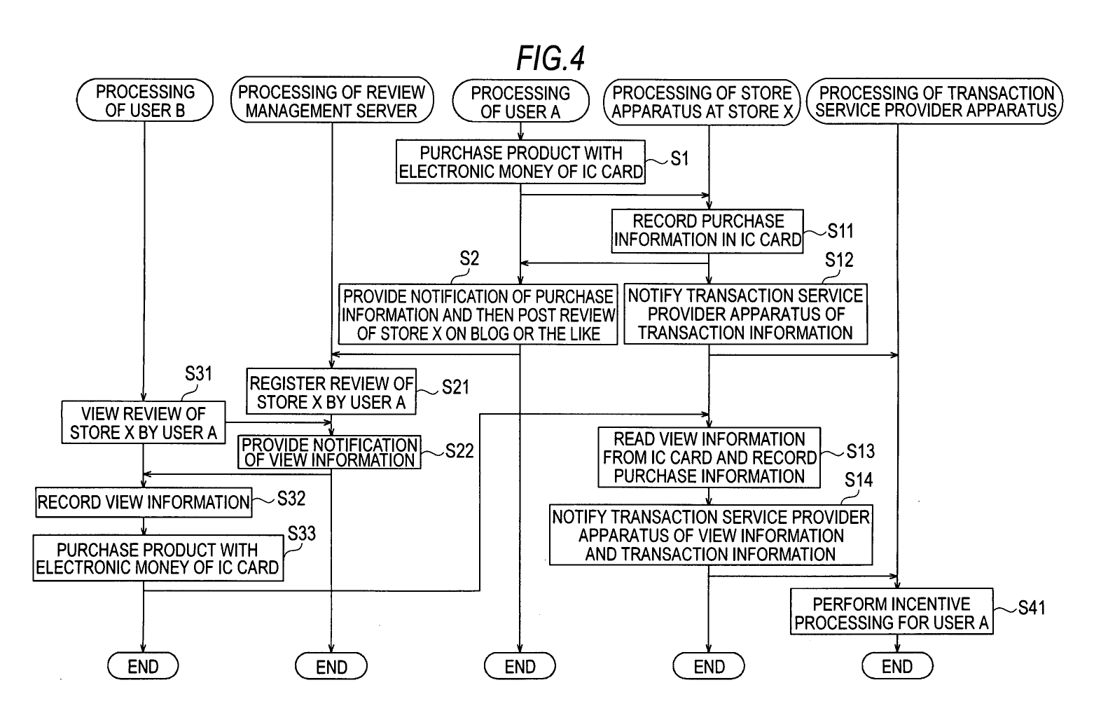

FIG. 4 is a flowchart for explanation of operations of the IC card utilization system 10.

In the operation explanation, a user A and a user B appear and the user A uses an IC card 21A and an information processing apparatus 22A and the user B uses an IC card 21B and an information processing apparatus 22B.

When the user A purchases a product at a store X, if the user touches the communication port of the store apparatus 12 set in the store X with the IC card 21A that functions as electronic money, at step S1, communication for transaction is made between the IC card 21A and the store apparatus 12.

Subsequently, the store apparatus 12 transmits usage information to the IC card 21A at step S11. The usage information is recorded in the memory 27 of the IC card 21A, and may include at least a user ID, a store ID and a date of use. At step S12, the store apparatus 12 notifies the transaction service provider apparatus 13 of usage information corresponding to the product purchase of the user A (purchase information), information indicating that the user A has visited the store (visit information), a combination of purchase information and visit information, or some other kind of information. The usage information is also provided to the review management server 14 by the transaction service provider apparatus 13.

The user A who has finished the product purchase returns home or the like, at step S2, the user uploads reviews of the store X and the purchased product to the review management server 14 using the information processing apparatus 22A.

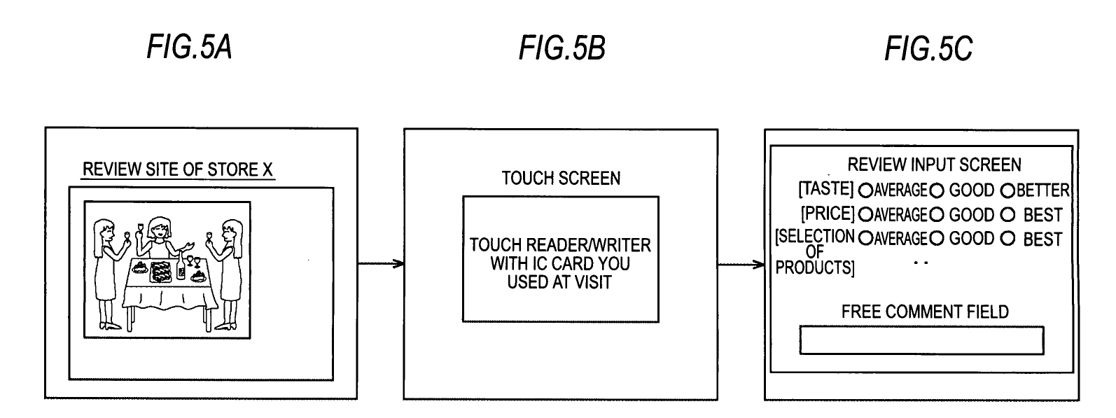

Specifically, when the information processing apparatus 22A accesses the review management server 14 in response to the operation of the user A, for example, a top page of a review site on which the reviews of the store X are disclosed as shown in FIG. 5A is displayed on the screen of the information processing apparatus 22A. Note that the URL for access to the review management server 14 has been known by the user A using an arbitrary search engine or the like or at the store X.

Then, the screen of the information processing apparatus 22A transits to a page prompting the user to touch the communication port with the IC card 21A as shown in FIG. 5B. If the user A in response to the prompt touches the communication port (the IC card communication unit 36) of the information processing apparatus 22A with the IC card 21A, the usage information supplied from the store X and recorded in the memory 27 of the IC card 21A is read out into the information processing apparatus 22A. The information processing apparatus 22A notifies the review management server 14 of the usage information read out from the IC card 21A.

In the review management server 14, whether the user A has actually purchased the product at the store X or not is confirmed based on the provided usage information and the transaction information supplied via the transaction service provider apparatus 13. If the product purchase by the user A has been confirmed, a review input page as shown in FIG. 5C is displayed on the information processing apparatus 22A.

If the user A finishes writing of the review on the review input page and performs a predetermined operation, the review by the user A is transmitted from the information processing apparatus 22A to the review management server 14.

Note that, on the basis of the usage information read out from the IC card 21A, the information processing apparatus 22A or the review management server 14 may automatically write predetermined items (for example, the date of transaction, the amount of purchase, the name of product, etc.) on the review input page for the user A.

At step S21, the review management server 14 registers the reviews by the user A transmitted from the information processing apparatus 22A in the review site. In some embodiments, the review management server may register the reviews by the user A based on certificate information provided by a certificate apparatus. That is, the reviews of the user A are uploaded to the review management server when the appropriate certificate information is provided by the certificate issuing apparatus. Thereby, the reviews of the store X and the purchased product by the user A are disclosed on the review management server 14.

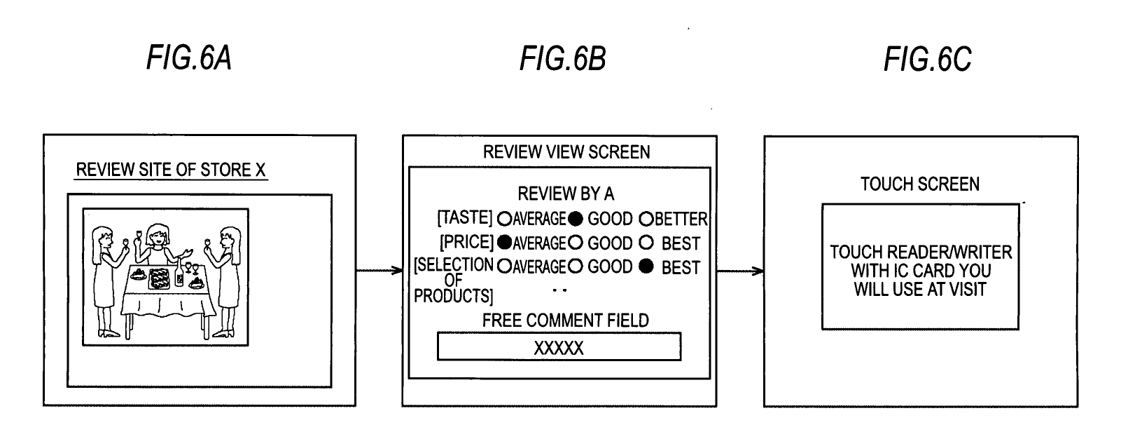

On the other hand, at step S31, if the user B uses the information processing apparatus 22B to access the review management server 14, for example, a top page of a review site on which the reviews of the store X are disclosed as shown in FIG. 6A is displayed on the screen of the information processing apparatus 22B. Note that the URL for access to the review site has been known by the user B using an arbitrary search engine or the like.

Then, if the user B performs move operation to the page on which the reviews of the store X are disclosed, data for displaying the page (HTML data or the like) is transmitted from the review management server 14 to the information processing apparatus 22B. The screen of the information processing apparatus 22B that has received the data transits to a page showing the reviews by the user A as shown in FIG. 6B.

If the user B performs a predetermined operation for the screen, at step S22, view information that proves the user B has viewed the review of the user A for the store X is provided from the review management server 14 to the information processing apparatus 22B. Alternatively, the view information may be provided from the review management server to the information processing apparatus 22B without the need for user B to perform a predetermined operation for the screen. The view information may include a coupon (for discount, free gift, or the like) available at the store X.

At step S32, the information processing apparatus 22B that has received the view information displays a page prompting the user to touch the communication port with the IC card 21B as shown in FIG. 6C on the screen. If the user B in response to the prompt touches the communication port of the information processing apparatus 22B with the IC card 21B, the view information transmitted from the review management server 14 is recorded in the memory 27 of the IC card 21B.

Then, when the user B purchases a product at the store X, if the user touches the communication port of the store apparatus 12 set in the store X with the IC card 21B in which the view information has been recorded, at step S33, transaction is performed between the IC card 21B and the store apparatus 12.

Subsequently, the store apparatus 12 reads out the view information from the IC card 21B and transmits purchase information to the IC card 21B at step S13. The purchase information is recorded in the memory 27 of the IC card 21B.

Thereby, the user B as well as the user A can upload the reviews of the store X and the purchased product to the review management server 14 for disclosure.

At step S14, the store apparatus 12 notifies the transaction service provider apparatus 13 of the transaction information corresponding to the product purchase by the user B and the view information read out from the IC card 21B.

At step S41, the transaction service provider apparatus 13 confirms that the user B has purchased the product at the store X after viewing the review by the user A for the store X based on the transaction information and the view information provided from the store apparatus 12. If the apparatus has confirmed that, the apparatus performs predetermined incentive processing for the user A. As the incentive processing, for example, a coupon (for discount, free gift, or the like) available at the store X or the like is issued to the user A, remuneration is paid, or a point showing the reliability of the page itself in which the review of the store X by the user A is disclosed is raised. This is the end of the operations of the IC card utilization system 10.

As explained above, according to the IC card utilization system 10, the user A may be subjected to the incentive processing if the user B uses the store X according to the review of the store X of his or her own. The user B may know the review of another person (user A) regarding the store X in advance. Further, if the view information includes a coupon or the like, the user B may advantageously purchase the product compared to the case where the user B uses the store X without viewing.

The store X can disclose the reviews provided from customers without establishing a homepage or the like by itself, and thereby, may expect increase of customers.

Note that, in the above described explanation, the users A, B have used the IC cards 21 and the information processing apparatus 22, however, the same operations may be executed using cellular phones including the IC chips equivalent to the IC cards 21.

### 2. Second Embodiment

### Configuration Example of Portable Terminal Utilization System 50

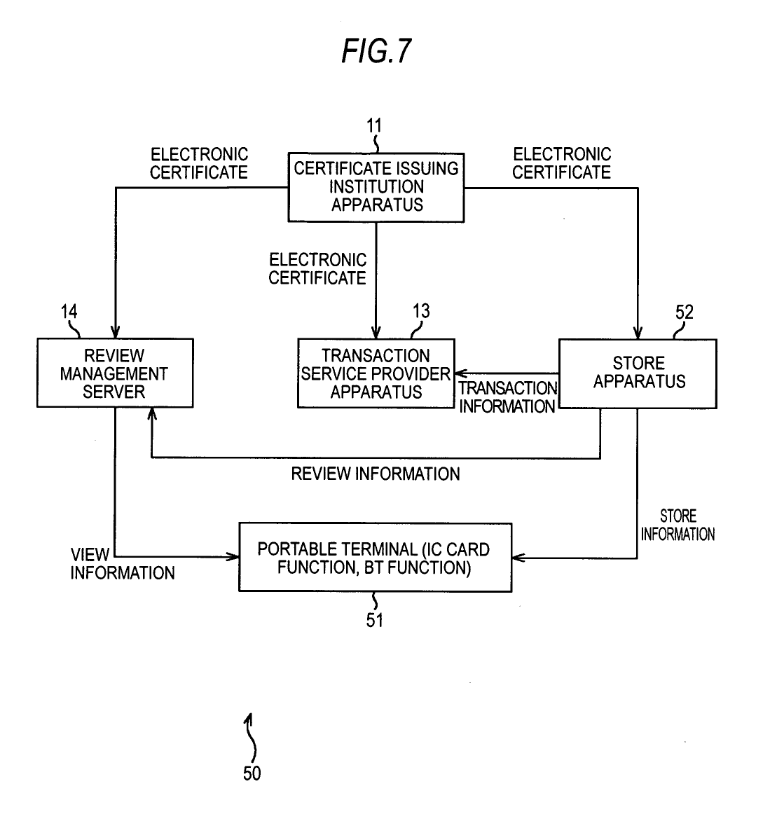

Next, FIG. 7 shows a configuration example of a portable terminal utilization system 50 as the second embodiment of the invention. The portable terminal utilization system 50 includes a certificate issuing institution apparatus 11, a transaction service provider apparatus 13, a review management server 14, a portable terminal 51 used by a user, and store apparatus 52.

Of them, the certificate issuing institution apparatus 11, the transaction service provider apparatus 13, and the review management server 14 are the same as those of the IC card utilization system 10 shown in FIG. 1, and their explanation will be omitted.

The portable terminal 51 is portable electronic apparatus at least having an IC card function that operates in the same manner as the above described IC card 21, a wireless communication function different from the IC card function (for example, Bluetooth, Wi-Fi, or the like), and a function of being accessible to an arbitrary server (for example, the review management server 14) via the Internet, and specifically, may be a cellular phone, a smart phone, a netbook computer, or the like.

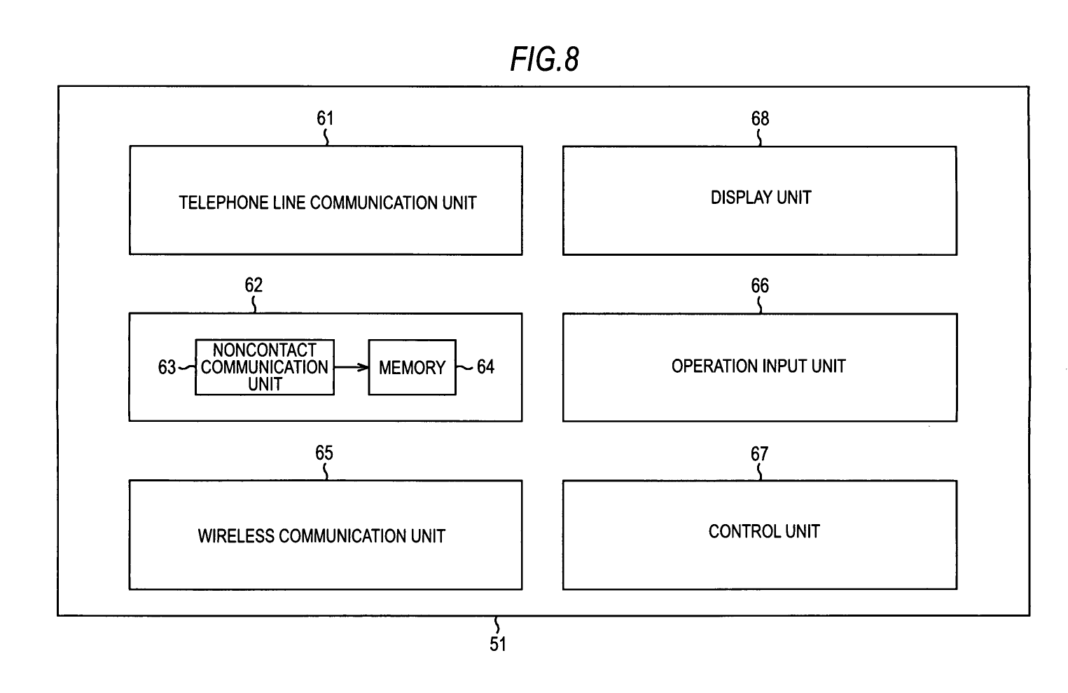

FIG. 8 shows a configuration example of a functional block of the portable terminal 51. The portable terminal 51 includes a telephone line communication unit 61, an IC card function unit 62, a wireless communication unit 65, an operation input unit 66, a control unit 67, and a display unit 68.

The telephone line communication unit 61 makes communication of sounds and various kinds of data via cellular phone lines. The IC card function unit 62 is realized by an IC chip equivalent to the IC card 21 and includes a noncontact communication unit 63 and a memory 64 inside. The wireless communication unit 65 makes wireless communication of data according to predetermined wireless communication standards of Bluetooth, Wi-Fi, or the like.

The operation input unit 66 accepts operation input from the user. The control unit 67 controls the respective units of the portable terminal 51. The display unit 68 displays a screen based on store information transmitted from the store apparatus 52.

Returning to FIG. 7, the store apparatus 52 is set in a store such as a restaurant that provides meals or the like, and provided with a communication port for noncontact data communication with the IC card function unit 62 of the portable terminal 51. Further, in the store apparatus 52, a wireless communication unit (not shown) for wireless data communication with the wireless communication unit 65 of the portable terminal 51 is provided.

The communication port of the store apparatus 52 is used when the user of the portable terminal 51 visits and at transaction (at touching with the portable terminal 51 used). The wireless communication unit of the store apparatus 52 is used while the user of the portable terminal 51 is present within the store.

For example, the store apparatus 52 performs noncontact communication with the portable terminal 51 in response to the touch to the communication port by the visitor (user) with the portable terminal 51, and then, promptly switches to wireless communication (handover). Then, the apparatus transmits the store information to the portable terminal 51 via wireless communication. The store information includes data for displaying a menu in the store, a questionnaire of reviews of the store and products, etc. on the portable terminal 51.

The user of the portable terminal 51 may place an order by selecting the menu displayed based on the store information (the data showing orders is transmitted to the store apparatus 52 by the wireless communication unit 65). Further, the user of the portable terminal 51 may answer the questionnaire displayed based on the store information (the data showing answers is transmitted to the store apparatus 52 by the wireless communication unit 65).

The store apparatus 52 issues a coupon (for discount, free gift, or the like) in response to the answering to the questionnaire by the user of the portable terminal 51 and transmits it to the portable terminal 51. The user of the portable terminal 51 may perform transaction using the issued coupon by touching the communication port of the store apparatus 52 with the portable terminal 51 at payment when leaving.

Furthermore, the store apparatus 52 is adapted to upload the answer to the questionnaire (the review by the user) transmitted from the portable terminal 51 to the review management server 14.

### [Operation Explanation of Portable Terminal Utilization System 50]

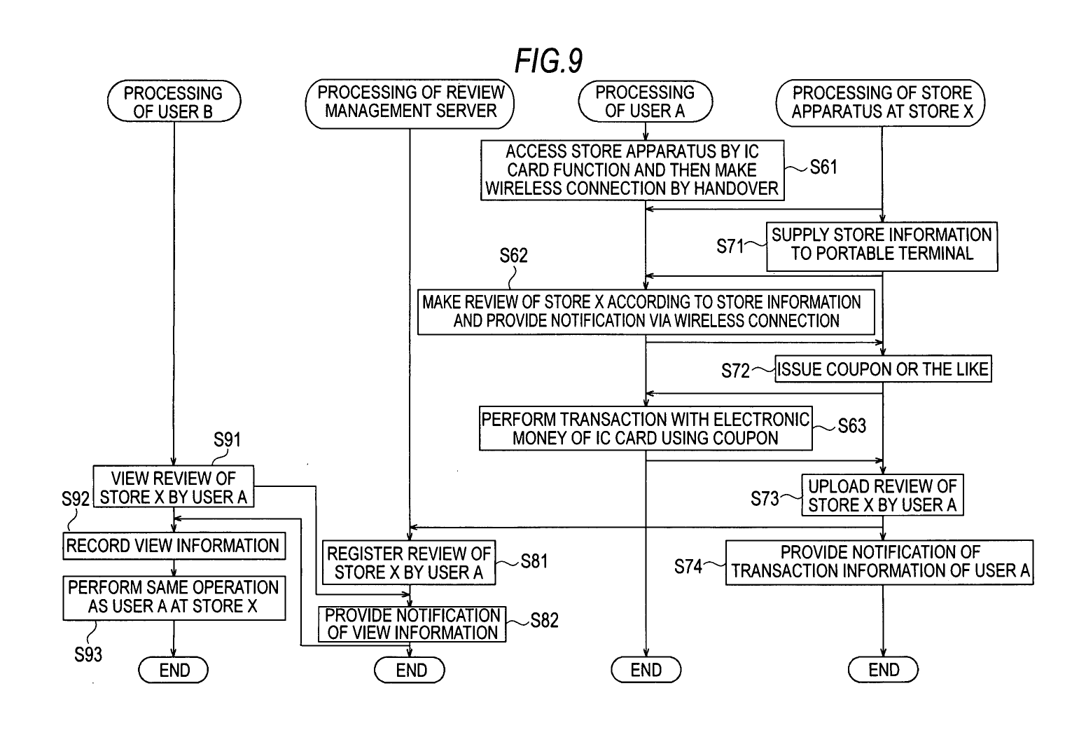

Next, FIG. 9 is a flowchart for explanation of operations of the portable terminal utilization system 50.

In the operation explanation, a user A and a user B appear and the user A uses a portable terminal 51A and the user B uses a portable terminal 51B.

When the user A visits a store X (for example, a restaurant) and touches the communication port of the store apparatus 52 set at the entrance or the like with the portable terminal 51A, at step S61, noncontact communication is performed between the IC card function unit 62 of the portable terminal 51A and the communication port of the store apparatus 52. Further, by handover, a connection via wireless communication is established between the wireless communication unit 65 of the portable terminal 51A and the wireless communication unit of the store apparatus 52. Therefore, even when the user A moves into the store, the connection between the portable terminal 51A and the store apparatus 52 is maintained.

At step S71, the store apparatus 52 transmits store information (a menu, a questionnaire, etc.) to the portable terminal 51A.

The portable terminal 51A that has received the store information presents a menu to the user A (displays it on the screen) based on the store information. When the user

A selects a product (meal) from the menu, the data indicating the order is transmitted to the store apparatus 52 by the wireless communication unit 65. Further, the portable terminal 51A presents a questionnaire to the user A (displays it on the screen) based on the store information. When the user A inputs answers to the questionnaire (reviews of the store and the product (meal)) before leaving, the data indicating the answers is transmitted to the store apparatus 52 by the wireless communication unit 65.

In response to the transmission of the answer to the questionnaire from the portable terminal 51A, at step S72, the store apparatus 52 issues and transmits a coupon to the portable terminal 51A. The coupon is recorded in the memory 64 of the portable terminal 51A.

Then, If the user A touches the communication port of the store apparatus 52 with the portable terminal 51A at payment when leaving, at step S63, transaction using the issued coupon is performed by the IC card function unit 62 of the portable terminal 51A.

If the transaction of the user A is completed, at step S73, the store apparatus 52 uploads the answer to the questionnaire (the review by the user A) transmitted from the portable terminal 51A to the review management server 14. Further, the store apparatus 52 notifies the transaction service provider apparatus 13 of transaction information corresponding to the product purchase by the user A.

At step S81, the review management server 14 registers the reviews by the user A transmitted from the store apparatus 52 in a review site. Thereby, the reviews of the store X and the product by the user A are disclosed on the review management server 14.

On the other hand, at step S91, if the user B uses the portable terminal 51B to access the review management server 14, and views the review site on which the reviews of the store X are disclosed. In response to this, at step S82, the review management server 14 notifies the portable terminal 51B of view information that proves the user B has viewed the review site for the store X. The view information includes a coupon (for discount, free gift, or the like) available at the store by the user B.

At step S92, the portable terminal 51B that has received it records the view information transmitted from the review management server 14 in the memory 64 within.

Then, if the user B visits the store X and touches the communication port of the store apparatus 52 with the portable terminal 51B, at step S93, the same processing as that at the above described steps subsequent to the step 61 is performed. This is the end of the operations of the portable terminal utilization system 50.

Note that the portable terminal 51B of the user B is different from the portable terminal 51A of the user A in that the coupon available at the store X is recorded therein. Therefore, if the user B has answered to the questionnaire of the store X, the user B has the coupon obtained by viewing the review site of the store X and the coupon obtained by answering the questionnaire at payment. Whether both of these coupons are available or not may be determined by the store X.

As explained above, according to the portable terminal utilization system 50, the user A selects a menu (order) and answers a questionnaire using only the portable terminal 51A of his or her own. Further, the user A may obtain a coupon by answering the questionnaire.

The user B may not only know the review of another person (user A) regarding the store X in advance but also obtain a coupon available at the store X before visiting the store.

The store X can disclose the reviews provided from customers on a homepage or the like by itself without summation of questionnaires using manpower or uploading the result, and thereby, may expect increase of customers.

### 3. Third Embodiment

### Configuration Example of IC Card Utilization System 80

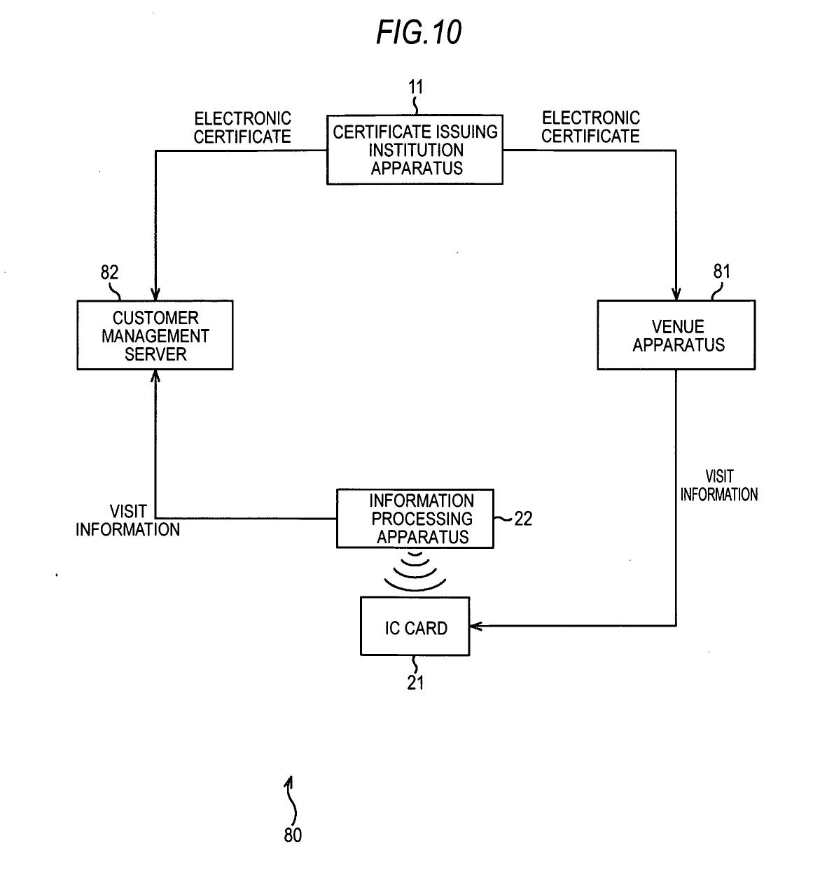

Next, FIG. 10 shows a configuration example of an IC card utilization system 80 as the third embodiment of the invention. The IC card utilization system 80 includes a certificate issuing institution apparatus 11, an IC card 21 and an information processing apparatus 22 used by a user, venue apparatus 81, and a customer management server 82.

Of them, the certificate issuing institution apparatus 11, the IC card 21, and the information processing apparatus 22 are the same as those in the IC card utilization system 10 shown in FIG. 1, and their explanation will be omitted.

The venue apparatus 81 is set in a venue where many visitors are expected such as an event venue for a concert or the like, an amusement park, a zoo, or the like, and provided with a communication port (not shown) for noncontact data communication with the IC card 21. When a person touches the communication port with the IC card 21, visit information with an electronic certificate attached is supplied from the venue apparatus 81 to the IC card 21. The visit information is recorded in the memory 27 of the IC card 21.

The visit information includes not only information indicating visiting but also the date of visit, venue information for identification of the venue, the number of visits, a URL of a server that discloses information relating to the venue (in this case, the customer management server 82). Regarding the number of visits, the value currently recorded in the IC card 21 may be incremented.

The customer management server 82 transmits visitors-only information to the information processing apparatus 22 that has accessed according to the URL contained in the visit information read out from the IC card 21. Here, the visitors-only information may include an URL of a site at which articles and services (tickets for the next concert etc.) relevant to the venue, an artist who holds the event, or the like are limitedly sold or the like.

### [Operation Explanation of IC Card Utilization System 80]

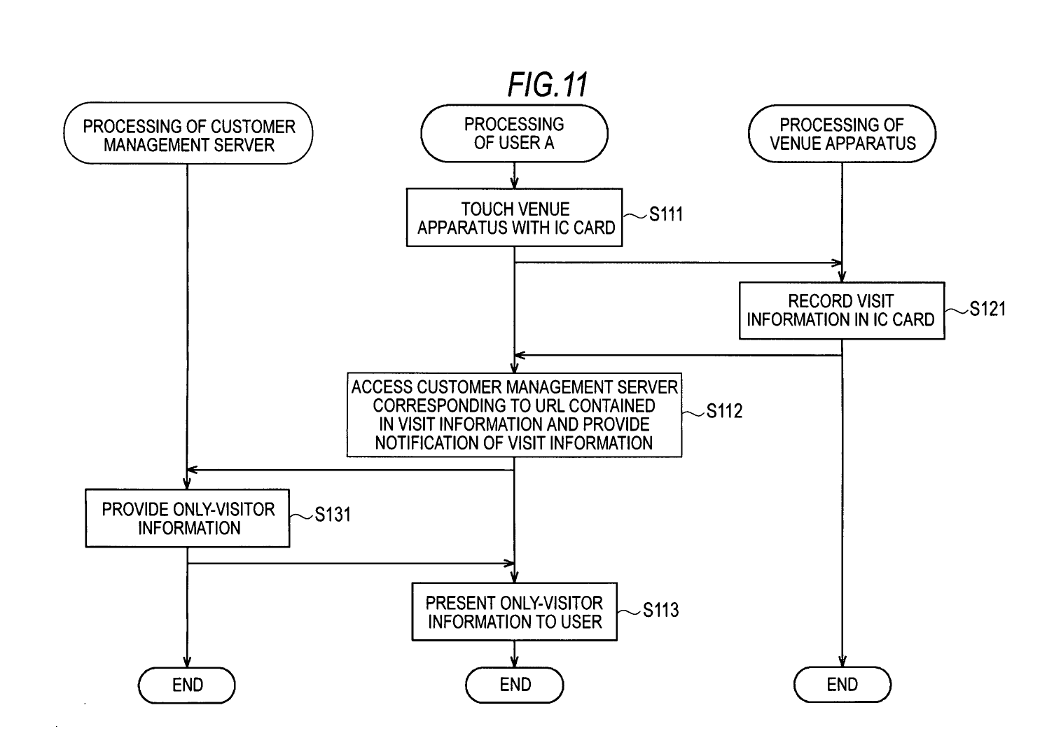

Next, FIG. 11 is a flowchart for explanation of operations of the IC card utilization system 80.

In the operation explanation, a user A uses an IC card 21A and an information processing apparatus 22A.

If the user A visits a concert venue or the like and touches the communication port of the venue apparatus 81 set there with the IC card 21A, at step S111, a connection via noncontact communication is made between the IC card 21A and the venue apparatus 81. Subsequently, at step S121 the venue apparatus 81 transmits visit information to the IC card 21A. The visit information is recorded in the memory 27 of the IC card 21A.

In order that the user A naturally performs an operation to touch the communication port of the venue apparatus 81, for example, the IC card 21A may be sold as an admission ticket of the concert.

If the user A who has left the concert venue returns home or the like and, at step S112, touches the communication port (the IC card communication unit 36) of the information processing apparatus 22A with the IC card 21, the information processing apparatus 22A reads out the visit information recorded in the memory 27 of the IC card 21. Further, the information processing apparatus 22A accesses the customer management server 82 according to the URL contained in the read out visit information and notifies the customer management server 82 of the visit information.

At step S131, the customer management server 82 confirms whether the user of the information processing apparatus 22A who has accessed has really visited the event venue or not based on the provided visit information. Then, if it is confirmed that the user has really visited the event venue, the server transmits the visitors-only information to the information processing apparatus 22A.

The information processing apparatus 22A that has received the visitors-only information presents information (a site where limited sales are conducted etc.) based on the visitors-only information to the user A at step S113. This is the end of the operation of the IC card utilization system 80.

As explained above, according to the IC card utilization system 80, the user A may acquire visitors-only information relevant to the concert that the user A attended or the like. A host of the concert may effectively sell related products, tickets of the next concert, etc. Therefore, increase of customers may be expected at less cost.

In the above explanation, the user A has used the IC card 21A and the information processing apparatus 22A, however, the same operation may be executed using a cellular phone containing an IC chip equivalent to the IC card 21.

In this specification, the system refers to an entire system including plural apparatuses.

The embodiments of the invention are not limited to the above described embodiments, but various changes may be made without departing from the scope of the invention.

1. A communication method for use when an integrated circuit (IC) device is used to conduct a near field communication (NFC) between the IC device and a store apparatus, the method comprising:
receiving usage information concerning the IC device through the store apparatus at a server, and storing the usage information in the server, the usage information being associated with the IC device, and the usage information being stored in the IC device;
comparing the usage information stored in the IC device to the usage information stored in the server; and
receiving review information related to the IC device at the server based on certification information, the certification information certifying that the usage information stored in the IC device corresponds to the usage information stored in the server.

2. A communication method as recited in claim 1, wherein the server transmits user view information indicating that another user has viewed the review to an IC device of the another user.

3. A communication method as recited in claim 2, wherein the store apparatus reads out the user view information from the IC device of the another user and performs predetermined incentive processing based on the user view information.

4. A communication method as recited in claim 2, wherein the IC device receives the user view information via a user apparatus.

5. A communication method as recited in claim 1, wherein the IC device is an IC card or a cellular phone.

6. A communication method as recited in claim 1, wherein the review information includes store information associated with the store apparatus.

7. A communication method as recited in claim 1, wherein the review information includes a purchased product.

8. An IC device comprising:
a noncontact communication unit for performing NFC; and
a memory storing usage information transmitted from a store apparatus and view information transmitted from a server based on an indication that a review has been viewed through a device other than the IC device, wherein the view information is read out by an information processing apparatus communicating with the server.

9. An IC device as recited in claim 8, wherein the usage information comprises purchase information.

10. An IC device as recited in claim 8, wherein the usage information comprises visit information.

11. An IC device as recited in claim 8, wherein the noncontact communication unit provides the view information to the store apparatus through NFC.

12. A portable terminal comprising:
a noncontact communication unit for performing NFC; and
a memory storing usage information transmitted from a store apparatus and view information transmitted from a server based on an indication that a review has been viewed through a device other than the portable terminal, wherein the view information is read out by an information processing apparatus communicating with the server.

13. A portable terminal as recited in claim 12, wherein the noncontact communication unit provides the view information to the store apparatus through NFC.

14. A portable terminal as recited in claim 12, wherein the portable terminal is a cellular phone, a smart phone or a computer.

15. A portable terminal as recited in claim 12, further comprising a wireless communication unit.

16. A portable terminal as recited in claim 12, wherein the usage information comprises at least one of purchase information and visit, information.
